(19) United States
(12) Patent Application Publication
(10) Pub. No.: US 2025/0337300 A1
(43) Pub. Date: Oct. 30, 2025

(54) ELECTRIC VEHICLE COOLANT WARMING THERMAL SYSTEM

(71) Applicant: FCA US LLC, Auburn Hills, MI (US)

(72) Inventors: Prashant P Modi, Rochester, MI (US); Dhafar Al-Ani, Troy, MI (US)

(21) Appl. No.: 18/651,004

(22) Filed: Apr. 30, 2024

(51) Int. Cl. H02K 9/19; B60K 11/02; B60L 1/02; B60L 50/60; H02K 5/20; H02K 7/116; H02K 11/30

(52) U.S. Cl. CPC H02K 9/19; B60K 11/02; B60L 1/02; B60L 50/60; H02K 5/203; H02K 7/116; H02K 11/30

(57) ABSTRACT

A vehicle thermal system includes a coolant loop configured to circulate a coolant for heating/cooling of the electrified powertrain, an oil loop configured to circulate an oil thermal fluid for heating/cooling of the electrified powertrain, and a heat exchanger fluidly coupled to the coolant loop and the oil loop. An electric traction motor is fluidly coupled to the coolant loop and the oil loop, and an interior surface of the electric traction motor includes an electrically conductive heat paint coating configured to come into contact with at least one of the coolant and the oil thermal fluid for heating/cooling of the electric traction motor. A power source is electrically coupled to the heat paint coating and configured to selectively supply an electric current to heat the heat paint coating and thereby heat the coolant and/or oil thermal fluid to rapidly warm the electric traction motor during low temperature conditions.

### FIELD

The present application relates generally to vehicle thermal systems and, more particularly, to vehicle thermal systems with heat-paint coated components.

### BACKGROUND

Vehicle powertrain system efficiency often decreases significantly at sub-zero atmospheric conditions. For example, thermal management, lubrication management, and overall vehicle operation may experience significant challenges in such conditions. The challenges are even more pronounced with electrified powertrains as the battery module operation potentially degrades significantly at sub-zero operating temperature. As such, it is essential to quickly warm the battery systems for longevity, efficiency, and sustainability of the electrified powertrain. Thus, while such conventional systems do work well for their intended purpose, there is a desire for improvement in the relevant art.

### SUMMARY

According to one example aspect of the invention, an electric traction motor is provided. In one exemplary implementation, the electric traction motor includes a housing, a stator disposed within the housing, a rotor disposed within the housing, and an output shaft coupled to the rotor and configured for rotation therewith. The housing is configured to fluidly couple to an oil loop configured to circulate an oil thermal fluid for heating/cooling of the electric traction motor. An interior surface of the housing includes an electrically conductive heat paint coating configured to come into contact with the oil thermal fluid. The heat paint coating is connected to a power source and configured to selectively receive an electric current to heat the heat paint coating and thereby heat the oil thermal fluid to rapidly warm the electric traction motor during low temperature conditions.

In addition to the foregoing, the described electric traction motor may include one or more of the following features: wherein the heat paint coating is applied to interior sidewalls of the housing; wherein the heat paint coating is applied to an interior bottom wall of the housing; and one or more coolant channels formed in the housing, wherein the one or more coolant channels are configured to fluidly couple to a coolant loop configured to circulate a coolant for heating/cooling of the electric traction motor, and wherein an interior surface of the one or more coolant channels includes the electrically conductive heat paint coating, which is configured to come into contact with the coolant.

In addition to the foregoing, the described electric traction motor may include one or more of the following features: wherein the heat paint coating on the one or more coolant channels is connected to the power source and configured to selectively receive an electric current to heat the heat paint coating and thereby heat the coolant to rapidly warm the electric traction motor during low temperature conditions; and a gearbox operably coupled to the output shaft and including an oil sump configured to fluidly couple to the oil loop, wherein the oil sump includes the electrically conductive heat paint coating, which is configured to come into contact with the oil thermal fluid.

According to another example aspect of the invention, a thermal system for an electrified powertrain is provided. In one implementation, the thermal system includes a coolant loop configured to circulate a coolant for heating/cooling of the electrified powertrain, an oil loop configured to circulate an oil thermal fluid for heating/cooling of the electrified powertrain, and a heat exchanger fluidly coupled to the coolant loop and the oil loop and configured to facilitate an indirect heat exchange between the coolant and the oil thermal fluid. An electric traction motor is fluidly coupled to the coolant loop and the oil loop, and an interior surface of the electric traction motor includes an electrically conductive heat paint coating configured to come into contact with at least one of the coolant and the oil thermal fluid for heating/cooling of the electric traction motor. A power source is electrically coupled to the heat paint coating and configured to selectively supply an electric current to heat the heat paint coating and thereby heat the coolant and/or oil thermal fluid to rapidly warm the electric traction motor during low temperature conditions.

In addition to the foregoing, the described thermal system may include one or more of the following features: a high voltage (HV) battery system thermally coupled to the coolant loop; wherein the coolant heated by the heat paint coating is subsequently directed to the high voltage battery module for heating thereof; wherein the oil thermal fluid is heated by the heat paint coating and directed to the heat exchanger for heating of the coolant, which is subsequently directed to the HV battery system for heating thereof; and wherein an interior surface of the heat exchanger includes the heat paint coating configured to come into contact with at least one of the coolant and the oil thermal fluid for heating thereof.

In addition to the foregoing, the described thermal system may include one or more of the following features: wherein the electric traction motor includes a stator, a rotor, and an output shaft disposed within a housing; wherein the heat paint coating is applied to interior sidewalls of the housing; wherein the heat paint coating is applied to an interior bottom wall of the housing; and wherein the housing includes one or more coolant channels formed therein, wherein the one or more coolant channels are fluidly coupled to the coolant loop, and wherein an interior surface of the one or more coolant channels includes the electrically conductive heat paint coating, which is configured to come into contact with the coolant for selective heating thereof.

In addition to the foregoing, the described thermal system may include one or more of the following features: a gearbox operably coupled to the electric traction motor and including an oil sump fluidly coupled to the oil loop, wherein the oil sump includes the electrically conductive heat paint coating, which is configured to come into contact with the oil thermal fluid for selective heating thereof; a controller having one or more processors, the controller configured to monitor a temperature of the electrified powertrain to detect a low temperature condition thereof, and supply electric current from the power source to the heat paint coating when the low temperature condition is detected, to thereby heat the coolant and/or the oil thermal fluid for heating of the electrified powertrain; wherein the controller is configured to operate in a rapid heating mode by controlling one or more valves of the low temperature coolant loop to bypass a low temperature radiator; and wherein the low temperature condition is a temperature below 0° C.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic diagram of an example vehicle thermal system operating in a first mode in accordance with the principles of the present disclosure;

FIG. 2 is a schematic diagram of the vehicle thermal system of FIG. 1 operating in a second mode in accordance with the principles of the present disclosure;

FIG. 3 is schematic illustration of an example electric traction motor of the thermal system of FIG. 2, in accordance with the principles of the present disclosure; and

FIG. 4 is a schematic illustration of another example electric traction motor of the thermal system of FIG. 2, in accordance with the principles of the present disclosure.

### DETAILED DESCRIPTION

As previously described, vehicle powertrains, and particularly electrified powertrains, often experience reduced efficiency in sub-zero temperatures (e.g., −40° C. to 0° C.). Accordingly, the present application is directed to a thermal system for rapidly warming electrified powertrains of electric vehicles. Example vehicles include, but are not limited to, mild hybrid electric vehicles (mHEVs), plug-in hybrid electric vehicles (PHEVs), battery electric vehicles (BEVs), and range extended electric vehicles (REEVs). While the thermal system is described for an electric vehicle, it will be appreciated that the systems and techniques described herein are applicable non-electric vehicles.

In the example embodiments, the thermal system is configured to warm electrified powertrain components such as, for example, electric machines, electric drive modules (EDMs), drive axles, etc. having (i) coolant systems such as water jackets, coolant channels, and coolant pumps, and/or (ii) oil systems such as oil channels, oil coolers, heat exchangers, oil pans, and oil pumps. Such thermal sub-systems utilize thermal fluids (e.g., coolant, water, oil) for thermal management of the electrified powertrain.

As described herein in more detail, the thermal system utilizes an electrically conductive thermal paint or heating paint, which is coated on the interior surfaces of the powertrain components that receive thermal fluid. The heating paint may be applied by any suitable process such as, for example, spraying, brushing, or printing. The heat paint coating is electrically coupled to an electric current source via attached probes. The heat paint coated surfaces are in direct contact with the thermal fluid and, when electric current is received, rapidly warm the thermal fluid to thereby quickly warm the electrified powertrain components. The size and thickness of the coating is variable and based on various factors such as, for example, required input energy (e.g., size of the electric current source), feasibility of the surfaces to be coated, warm-up time requirement, and heat paint coating chemical composition.

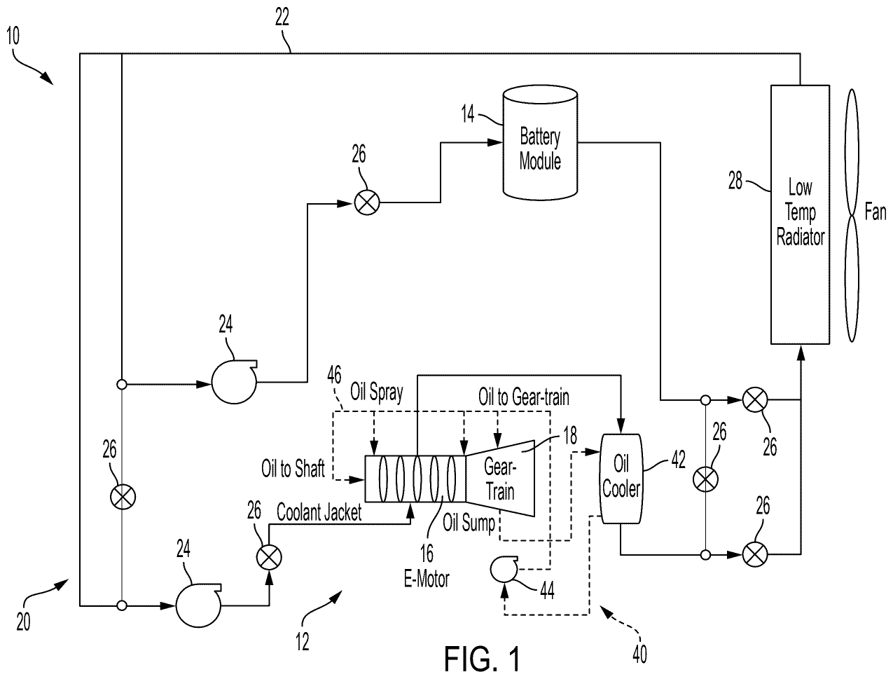

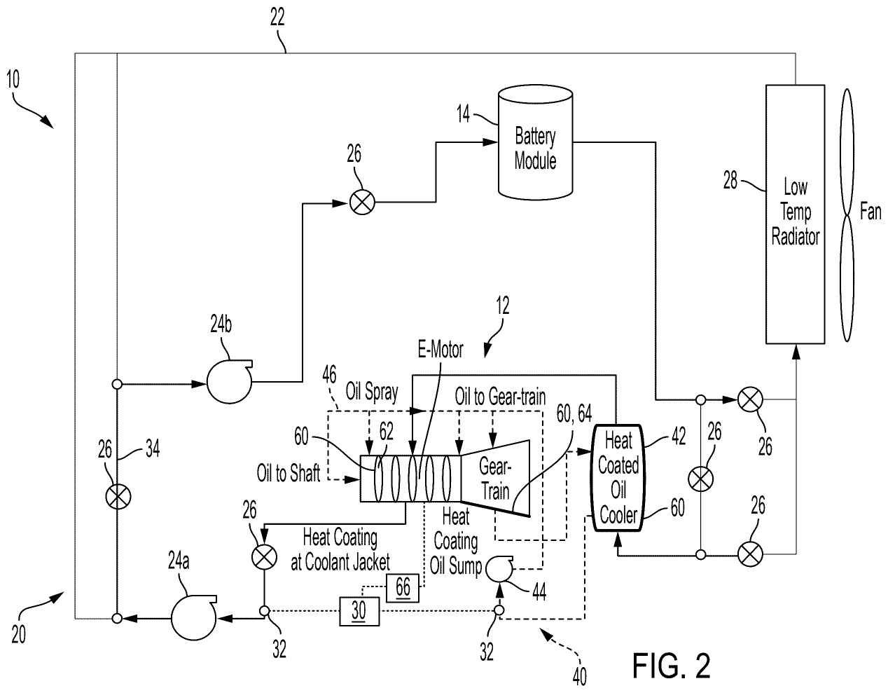

With initial reference to FIGS. 1 and 2, an example thermal system 10 for an electrified vehicle powertrain 12 is illustrated in accordance with the principles of the present disclosure. FIG. 1 illustrates the thermal system operating in a first or normal mode configured to cool components of the powertrain 12. FIG. 2 illustrates the thermal system operating in a second or rapid heating mode configured to warm/heat components of the powertrain 12, for example, during low temperature conditions.

Accordingly, in the example embodiment, the thermal system 10 is configured to provide heating/cooling to various components of the electrified powertrain 12 such as a high voltage battery module/system 14, an electric traction motor 16, and a gear train or gearbox 18 operatively associated with the electric traction motor 16. It will be appreciated that other components may be thermally coupled to thermal system 10 in addition to those illustrated, such as power electronics including an integrated dual charging module (IDCM) and power inverter module (PIM).

In the example embodiment, the thermal system 10 generally includes a low temperature coolant loop 20 and an oil loop 40. The low temperature coolant loop 20 selectively circulates a coolant (e.g., water) around a main circuit 22 to selectively provide cooling to the battery system 14 and electric traction motor 16. The oil loop 40 selectively circulates an oil (or other thermal fluid) for heating/cooling and lubricating portions of the electric traction motor 16 and gearbox 18.

In a general operation, shown in FIG. 1, oil is circulated in oil loop 40 to absorb heat and cool the electric traction motor 16 and gearbox 18. The resulting heated oil subsequently transfers heat to the low temperature coolant loop 20 via an indirect heat exchanger 42. The heated coolant is then directed to a heat exchanger (e.g., a radiator 28) for cooling before repeating the cycle. Additionally, coolant is circulated in coolant loop 20 to absorb heat and cool the battery system 14. The resulting heated coolant is then directed to the radiator for cooling before repeating the cycle.

However, in low temperature conditions, it is desirable to rapidly heat the electrified powertrain 12. Accordingly, in the example embodiment shown in FIG. 2, portions of the electric motor 16, gearbox 18, and/or the heat exchanger 42 include electrically conductive heat paint coating 60. In the illustrated example, the heat paint coating 60 is applied to interior surfaces of the electric motor 16, the gearbox 18, and/or the heat exchanger 42 which are in contact with the oil or coolant. Example interior surfaces include those of one or more water jackets 62, an oil sump 64, and the heat exchanger 42 (e.g., tubes, conduits, fins, etc.). However, it will be appreciated that heat paint coating 60 may be applied to any thermal fluid wetted surface in the thermal system 10. The heat paint coating 60 is electrically coupled to a power source 66, which is configured to selectively provide an electrical current to the heat paint coating 60 for heating thermal fluid in contact with the heat paint coating 60.

In the illustrated example, the low temperature loop 20 generally includes pumps 24, valves 26, and low temperature radiator 28. The pumps 24 are configured to circulate the coolant around the main circuit 22, and the valves 26 are selectively opened/closed to provide coolant to various portions of the low temperature coolant loop 20 as desired. In the illustrated example shown in FIG. 2, valves 26 are controlled to bypass the low temperature radiator 28 in the rapid heating mode to rapidly warm the electrified powertrain components. A controller 30 is configured to control pumps 24 and valves 26 to selectively direct coolant through desired branches of the low temperature loop 20.

In the example embodiment, the oil loop 40 generally includes the heat exchanger 42 and a pump 44. The pump 44 receives oil from the heat exchanger 42 and subsequently directs the oil to the electric motor 16 and the gearbox 18 via a conduit 46. The oil is directed through portions of the electric motor 16 and gearbox 18 before being directed to the oil sump 64. Oil is then directed from the oil sump 64 to the heat exchanger 42 and the cycle is repeated.

With continued reference to FIG. 2, the thermal system 10 is configured to operate in the rapid heating mode to rapidly heat the electrified powertrain 12, including the battery system 14, electric motor 16, and to some extent the gearbox 18, when their temperature is below a predetermined threshold (e.g., below 0° C.). In the example operation, controller 30 monitors and detects a low temperature condition, for example, via one or more sensors 32 (e.g., temperature sensor). When conditions are satisfied, the controller 30 initiates the rapid heating mode and activates the power source 66 to direct electric current to the heat paint coating 60. The controller 30 also controls valves 26 for the coolant flow to bypass the low temperature radiator 28. As a result, a temperature of the heat paint coating 60 increases to thereby heat the coolant/oil in contact therewith. In the example embodiment, the coolant is heated in water jackets 62 and heat exchanger 42, and the oil thermal fluid is heated in the electric motor 16, oil sump 64, and heat exchanger 42.

The oil pump 44 circulates oil through the oil loop 40 as it is rapidly warmed by the heat paint coating 60. The heated oil is passed through the heat exchanger 42 to thereby warm the coolant passing therethrough via coolant loop 20. Coolant pump 24a directs the warmed coolant through branch 34 to pump 24b, which then supplies the warmed coolant to battery system 14 for rapid warming thereof. The battery system 14 may include one or more high voltage batteries and associated electronics (not shown) thermally coupled to the coolant loop 20. In the example mode, valves 26 are actuated to bypass the low temperature radiator 28 to maximize heat retention. Thus, the coolant is directed from the battery system 14 back to the heat exchanger 42 for continued warming until the electrified powertrain 12 (or specific components thereof) reach a desired predetermined operating temperature.

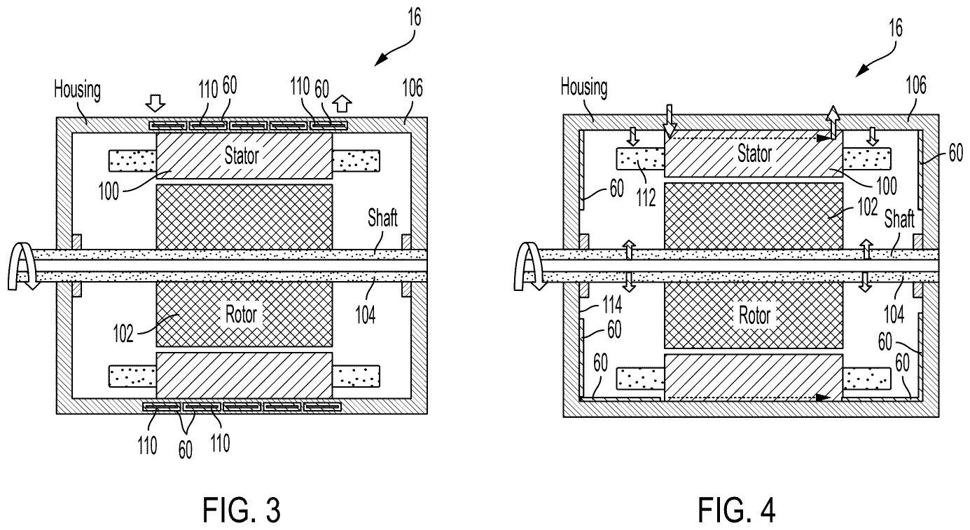

FIG. 3 illustrates one example embodiment of the electric traction motor 16, which generally includes a stator 100, a rotor 102, and an output shaft 104. The stator 100 is fixed to a housing 106, and the rotor 102 is configured to rotate relative to the stator 100 to drive the output shaft 104 and thus vehicle axles and wheels (not shown). In the example embodiment, a plurality of coolant channels 110 are formed in the housing 106 and fluidly coupled to the coolant loop 20. The inner surfaces of the coolant channels are coated with the heat paint coating 60. In this way, coolant passing through coolant channels 110 is selectively heated by the heat paint coating 60 disposed therein.

FIG. 3 illustrates an alternative or additional embodiment of the electric traction motor 16 where oil is sprayed on components inside the housing 106 (e.g., stator windings 112) and circulated through other components, such as the stator 100 and output shaft 104, as shown by the illustrated arrows. Interior surfaces 114 (e.g., sidewalls, bottom wall) of the housing 106 are coated with the heat paint coating 60, which comes into contact with the cooling oil provided within the housing 106. In this way, oil directed through the housing 106 is selectively heated by the heat paint coating 60 disposed therein.

Described herein are systems and methods for rapidly heating a high voltage battery system and/or powertrain of an electric vehicle during low temperature conditions to improve the high voltage battery system thermal warmup to operate at high efficiency and battery charge sustainability. The system uses an electrically conductive heat paint coating on thermal fluid wetted surfaces of a vehicle thermal system. The heat paint coating selectively receives electric current to provide direct and localized thermal fluid warmup without adding additional space, mass, and cost required by conventional heaters. The system advantageously provides target higher accuracy and resolution thermal fluid warmup, little to no added mass, reduced NVH and structural limitations, low manufacturing complexity, no packaging restraints, and relatively lower cost compared to conventional technologies.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. An electric traction motor, comprising:
a housing;
a stator disposed within the housing;
a rotor disposed within the housing; and
an output shaft coupled to the rotor and configured for rotation therewith,
wherein the housing is configured to fluidly couple to an oil loop configured to circulate an oil thermal fluid for heating/cooling of the electric traction motor, and
wherein an interior surface of the housing includes an electrically conductive heat paint coating configured to come into contact with the oil thermal fluid,
wherein the heat paint coating is connected to a power source and configured to selectively receive an electric current to heat the heat paint coating and thereby heat the oil thermal fluid to rapidly warm the electric traction motor during low temperature conditions.

2. The electric traction motor of claim 1, wherein the heat paint coating is applied to interior sidewalls of the housing.

3. The electric traction motor of claim 1, wherein the heat paint coating is applied to an interior bottom wall of the housing.

4. The electric traction motor of claim 1, further comprising one or more coolant channels formed in the housing,
wherein the one or more coolant channels are configured to fluidly couple to a coolant loop configured to circulate a coolant for heating/cooling of the electric traction motor, and
wherein an interior surface of the one or more coolant channels includes the electrically conductive heat paint coating, which is configured to come into contact with the coolant.

5. The electric traction motor of claim 4, wherein the heat paint coating on the one or more coolant channels is connected to the power source and configured to selectively receive an electric current to heat the heat paint coating and thereby heat the coolant to rapidly warm the electric traction motor during low temperature conditions.

6. The electric traction motor of claim 1, further comprising a gearbox operably coupled to the output shaft and including an oil sump configured to fluidly couple to the oil loop,
wherein the oil sump includes the electrically conductive heat paint coating, which is configured to come into contact with the oil thermal fluid.

7. A thermal system for an electrified powertrain, comprising:
a coolant loop configured to circulate a coolant for heating/cooling of the electrified powertrain;
an oil loop configured to circulate an oil thermal fluid for heating/cooling of the electrified powertrain;
a heat exchanger fluidly coupled to the coolant loop and the oil loop and configured to facilitate an indirect heat exchange between the coolant and the oil thermal fluid;
an electric traction motor fluidly coupled to the coolant loop and the oil loop, wherein an interior surface of the electric traction motor includes an electrically conductive heat paint coating configured to come into contact with at least one of the coolant and the oil thermal fluid for heating/cooling of the electric traction motor; and
a power source electrically coupled to the heat paint coating and configured to selectively supply an electric current to heat the heat paint coating and thereby heat the coolant and/or oil thermal fluid to rapidly warm the electric traction motor during low temperature conditions.

8. The thermal system of claim 7, further comprising a high voltage (HV) battery system thermally coupled to the coolant loop.

9. The thermal system of claim 8, wherein the coolant heated by the heat paint coating is subsequently directed to the high voltage battery module for heating thereof.

10. The thermal system of claim 8, wherein the oil thermal fluid is heated by the heat paint coating and directed to the heat exchanger for heating of the coolant, which is subsequently directed to the HV battery system for heating thereof.

11. The thermal system of claim 7, wherein an interior surface of the heat exchanger includes the heat paint coating configured to come into contact with at least one of the coolant and the oil thermal fluid for heating thereof.

12. The thermal system of claim 7, wherein the electric traction motor includes a stator, a rotor, and an output shaft disposed within a housing.

13. The thermal system of claim 12, wherein the heat paint coating is applied to interior sidewalls of the housing.

14. The thermal system of claim 12, wherein the heat paint coating is applied to an interior bottom wall of the housing.

15. The thermal system of claim 12, wherein the housing includes one or more coolant channels formed therein,
wherein the one or more coolant channels are fluidly coupled to the coolant loop, and
wherein an interior surface of the one or more coolant channels includes the electrically conductive heat paint coating, which is configured to come into contact with the coolant for selective heating thereof.

16. The thermal system of claim 7, further comprising a gearbox operably coupled to the electric traction motor and including an oil sump fluidly coupled to the oil loop,
wherein the oil sump includes the electrically conductive heat paint coating, which is configured to come into contact with the oil thermal fluid for selective heating thereof.

17. The thermal system of claim 7, further comprising a controller having one or more processors, the controller configured to:
monitor a temperature of the electrified powertrain to detect a low temperature condition thereof; and
supply electric current from the power source to the heat paint coating when the low temperature condition is detected, to thereby heat the coolant and/or the oil thermal fluid for heating of the electrified powertrain.

18. The thermal system of claim 17, wherein the controller is configured to operate in a rapid heating mode by controlling one or more valves of the low temperature coolant loop to bypass a low temperature radiator.

19. The thermal system of claim 17, wherein the low temperature condition is a temperature below 0° C.
